(19) United States
(12) Patent Application Publication
(10) Pub. No.: US 2011/0071254 A1
(43) Pub. Date: Mar. 24, 2011

(54) CURABLE COMPOSITIONS CONTAINING SILYLATED POLYETHER BLOCK POLYMER-BASED POLYURETHANES

(75) Inventors: Thomas Bachon, Duesseldorf (DE); Lars Zander, Rommerskirchen (DE); Sara Gonzalez, Barcelona (ES); Christiane Kunze, Koeln (DE); Johann Klein, Duesseldorf (DE); Daniela Braun, Shanghai (CN)

(73) Assignee: Henkel AG & Co. KGaA, Duesseldorf (DE)

(21) Appl. No.: 12/897,850

(22) Filed: Oct. 5, 2010

Related U.S. Application Data
(63) Continuation of application No. PCT/EP2009/054940, filed on Apr. 24, 2009.

(30) Foreign Application Priority Data
Apr. 25, 2008 (DE) 102008020980.5

(51) Int. Cl. C08L 83/04; C08G 18/08; C08G 59/14

(52) U.S. Cl. 524/588; 525/460; 525/523

(57) ABSTRACT

The invention relates to a silylated polyurethane that is manufactured by reacting at least one polyether compound having an OH number per DIN 53783 between 3 and 20 mg KOH/g, made up of at least two polyoxyalkylene blocks A and B, the number of carbon atoms in the alkylene units of blocks A and B differing by at least 1, with one or more isocyanatosilanes of formula (I): OCN—R—Si—(R¹)ₘ(—OR²)₃₋ₘ, in which m is 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the prepolymer with the isocyanatosilane, thereby forming a silylated polyurethane that comprises alkoxysilyl groups as reactive end groups. The silylated polyurethanes that are described are suitable for the manufacture of adhesive, sealant, or coating-agent preparations having good mechanical properties.

This application is a continuation of International Application No. PCT/EP2009/054940, filed Apr. 24, 2009 and published on Oct. 29, 2009 as WO 2009/130297, which claims priority from German Patent Application No. 102008020980.5 filed Apr. 25, 2008, which are incorporated herein by reference in their entirety.

The present invention relates to silane-crosslinking curable compositions, their manufacture, and their use in adhesives and sealants and in coating agents.

Polymer systems that possess reactive alkoxysilyl groups are known. In the presence of atmospheric moisture these alkoxysilane-terminated polymers are capable, already at room temperature, of condensing with one another with release of the alkoxy groups. What forms in this context, depending on the concentration of alkoxysilyl groups and their configuration, are principally long-chain polymers (thermoplastics), relatively wide-mesh three-dimensional networks (elastomers), or highly crosslinked systems (thermosetting plastics).

The polymers generally comprise an organic backbone that carries alkoxysilyl groups at the ends. The organic backbone can involve, for example, polyurethanes, polyesters, polyethers, etc.

One-component, moisture-curing adhesives and sealants have for years played a significant role in numerous technical applications. In addition to the polyurethane adhesives and sealants having free isocyanate groups, and the traditional silicone adhesives and sealants based on dimethylpolysiloxanes, the so-called modified silane adhesives and sealants have also been increasingly used recently. In this latter group, the main constituent of the polymer backbone is a polyether, and the reactive and crosslinkable terminal groups are alkoxysilyl groups. The modified silane adhesives and sealants have the advantage, as compared with the polyurethane adhesives and sealants, of being free of isocyanate groups, in particular of monomeric diisocyanates; they are also notable for a broad adhesion spectrum to a plurality of substrates without surface pretreatment using primers.

U.S. Pat. No. 4,222,925 A and U.S. Pat. No. 3,979,344 A describe siloxane-terminated organic sealant compositions, curable already at room temperature, based on reaction products of isocyanate-terminated polyurethane prepolymers with 3-am inopropyltrimethoxysilane or 2-aminoethyl- or 3-aminopropylmethoxysilane to yield isocyanate-free siloxane-terminated prepolymers. Adhesives and sealants based on these prepolymers have unsatisfactory mechanical properties, however, especially in terms of their elongation and breaking strength.

The methods set forth below for the manufacture of silane-terminated prepolymers based on polyethers have already been described:
Copolymerization of unsaturated monomers with ones that comprise alkoxysilyl groups, for example vinyltrimethoxysilane.
Grafting unsaturated monomers, such as vinyltrimethoxysilane, onto thermoplastics such as polyethylene.
Hydroxyfunctional polyethers are reacted with unsaturated chlorine compounds, e.g. allyl chloride, in an ether synthesis to yield polyethers having terminal olefinic double bounds, which in turn are reacted with hydrosilane compounds that have hydrolyzable groups, for example HSi(OCH₃)₃, in a hydrosilylation reaction under the catalytic influence of, for example, transition metal compounds of the eighth group, to yield silane-terminated polyethers.
In another method, the polyethers containing olefinically unsaturated groups are reacted with a mercaptosilane such as, for example, 3-mercaptopropyltrialkoxysilane.
In a further method, firstly hydroxyl-group-containing polyethers are reacted with di- or polyisocyanates, which are then in turn reacted with aminofunctional silanes or mercaptofunctional silanes to yield silane-terminated prepolymers.
A further possibility provides for the reaction of hydroxyfunctional polyethers with isocyanatofunctional silanes such as, for example, 3-isocyanatopropyltrimethoxysilane.

These manufacturing methods, and the use of the aforementioned silane-terminated prepolymers in adhesive/sealant applications, are recited e.g. in the following patent documents: U.S. Pat. No. 3,971,751 A, EP-A-70475, DE-A-19849817, U.S. Pat. No. 6,124,387 A, U.S. Pat. No. 5,990,257 A, U.S. Pat. No. 4,960,844 A, U.S. Pat. No. 3,979,344 A, U.S. Pat. No. 3,632,557 A, DE-A-4029504, EP-A-601021, or EP-A-370464.

EP-A-0931800 describes the manufacture of silylated polyurethanes by reacting a polyol component having a terminal unsaturation of less than 0.02 meq/g with a diisocyanate to yield a hydroxyl-terminated prepolymer, and then reacting that with an isocyanatosilane of the formula OCN—R—Si—(X)ₘ(—OR¹)₃₋ₘ, where m is 0, 1, or 2 and each R¹ residue is an alkyl group having 1 to 4 carbon atoms and R is a difunctional organic group. According to the teaching of this document, such silylated polyurethanes exhibited a superior combination of mechanical properties, and cure in reasonable amounts of time to yield a low-tack sealant without exhibiting excessive viscosity.

WO-A-2003 066701 discloses polyurethane prepolymers, comprising alkoxysilane terminal groups and OH terminal groups, based on high-molecular-weight polyurethane prepolymers with decreased functionality, for use as binding agents for low-modulus sealants and adhesives. For this, firstly a polyurethane polymer, made up of a diisocyanate component having an NCO content from 20 to 60% and a polyol component encompassing a polyoxyalkylene dial having a molecular weight between 3000 and 20,000 as a main component, is to be reacted, the reaction to be stopped at a 50 to 90% OH group conversion yield. This reaction product is then to be further reacted with a compound comprising alkoxysilane groups and amino groups. These actions are said to yield prepolymers having a comparatively low average molecular weight and low viscosity, which are said to ensure that a high level of properties is obtained.

WO-A-2005 042605 discloses moisture-curing alkoxysilane-functional polyether urethane compositions that contain 20 to 90 wt % of a polyether urethane A having two or more reactive silane groups, and 10 to 80 wt % of a polyether urethane B having one reactive silane group. Polyether urethane A is said to comprise polyether segments having a number-average molecular weight (Mₙ) of at least 3000 and an unsaturation of less than 0.04 meq/g, and the reactive silane groups are to be inserted by reaction of an isocyanate-reactive group with a compound of the formula OCN—Y—Si—(X)₃. Polyether urethane B is to comprise one or more polyether segments having a number-average molecular weight (Mₙ) from 1000 to 15,000, and the reactive silane groups are to be inserted by reacting an isocyanate group with a compound of the formula HN(R₁)—Y—Si—(X)₃. R₁ here is an alkyl, cycloalkyl, or aromatic group having 1 to 12 carbon atoms, X an alkoxy group, and Y a linear radical having 2 to 4 carbon atoms or a branched radical having 5 to 6 carbon atoms.

To reduce the functionality, and thus the crosslinking density, of moisture-curing alkoxysilane-terminated polyurethanes, WO-A-92/05212 proposes the concurrent use of monofunctional isocyanates mixed with diisocyanates in the context of synthesis. Monoisocyanates are known to have a very high vapor pressure, and are objectionable ingredients in terms of industrial hygiene because of their toxicity.

EP-A-1396513 describes a composition that cures at room temperature and contains a polyoxyalkylene polymer (A), having a molecular weight from 8000 to 50,000 (calculated from the hydroxyl number), that comprises hydrolyzable silicon groups of the formula —SiXₐR¹₃₋ₐ, in which X is a hydroxyl group or a hydrolyzable group, a is 1, 2, or 3, and R¹ is a C₁₋₂₀-substituted or unsubstituted monovalent organic group. The composition is to contain both polyoxyalkylene polymers (A) in which a is 1 or 2, and ones in which a is 3. If more than one R¹ is present, the majority of R¹ can be the same or different; and if more than one X is present, the majority of X can be the same or different. The composition that cures at room temperature is to be usable as a sealing compound, impregnation agent, adhesive, or coating agent.

WO-A-2005 047394 discloses crosslinkable compositions that are manufacturable using a mixture of two or more polyols; at least two different polyoxyalkylenes are to be used for this, at least one first oxyalkylene unit comprising at least two carbon atoms between two adjacent oxygen atoms, and at least one second oxyalkylene unit comprising at least one more carbon atom between two adjacent oxygen atoms than the first oxyalkylene unit. The reaction of a mixture of polypropylene glycol and poly-THF with toluylene diisocyanate, and subsequent reaction with isocyanatopropyltrimethoxysiloxane to yield a moisture-curing polymer, is described as an example.

A need still exists for isocyanate-free compositions for the manufacture of one- or two-component adhesives and sealants or coating agents that exhibit an acceptable curing time and particularly good elasticity and extensibility after curing. A desire also exists for an efficient synthesis route, and for compositions that exhibit no residual tackiness.

The object of the present invention is therefore to make available isocyanate-free crosslinkable compositions that exhibit high elasticity and good strength with a very low modulus of elasticity. A user-friendly curing time is also desired.

The manner in which the object is achieved by the invention may be gathered from the Claims. It involves substantially making available a method for manufacturing a silylated polyurethane, encompassing reaction of at least one polyether compound having an OH number per DIN 53783 between 3 and 20 mg KOH/g, made up of at least two polyoxyalkylene blocks A and B, the number of carbon atoms in the alkylene units of blocks A and B differing by at least 1, with one or more isocyanatosilanes of formula (I)

OCN—R—Si—(R¹)ₘ(—OR²)₃₋ₘ (I)

in which m is 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the polyether compound with the isocyanatosilane.

The invention also relates to a silylated polyurethane that is manufactured by reacting at least one polyether compound having an OH number per DIN 53783 between 3 and 20 mg KOH/g, made up of at least two polyoxyalkylene blocks A and B, the number of carbon atoms in the alkylene units of blocks A and B differing by at least 1, with one or more isocyanatosilanes of formula (I)

OCN—R—Si—(R¹)ₘ(—OR²)₃₋ₘ (I)

in which m is 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the prepolymer with the isocyanatosilane, thereby forming a silylated polyurethane that comprises alkoxysilyl groups as reactive terminal groups.

“Silylated polyurethanes” for purposes of this invention are also those compounds that comprise more than one, but fewer than three, urethane groups per molecule.

Polyether compounds of the A-B-A block copolymer type are usable with particular preference.

In a further preferred embodiment of the present invention, the polyether compound has an OH number between 6 and 12 mg KOH/g.

In a further preferred embodiment of the present invention, the polyoxyalkylene blocks A and B are connected to one another by ether bonds. This results, advantageously, in improved elasticity for the polyether compound and therefore also for the silylated polyurethane according to the present invention, as compared with a linkage via, for example, ester or urethane groups. These two last-named groups form hydrogen bridge bonds, thereby lowering the elasticity of the polymers. An “ether bond” is understood in the context of the present invention as the linkage of two organic residues via an oxygen atom, so that a structural element of the form R^{b}—O—R^{b} is present. In this structure, presented solely for purposes of explanation, R^{b} (b=arbitrary) denotes any arbitrary organic residue.

In a further preferred embodiment of the present invention, polyoxyalkylene block A comprises alkylene units having an even number of carbon atoms, and polyoxyalkylene block B comprises alkylene units having an odd number of carbon atoms.

If applicable, the polyether compound made up of at least two polyoxyalkylene blocks A and B can be reacted in a preceding reaction with a diisocyanate, with a stoichiometric excess of the polyol compounds with respect to the diisocyanate compound, to yield a polyurethane prepolymer that is hydroxyl-terminated. The latter is then further reacted with one or more isocyanatosilanes of formula (I) to yield a silylated polyurethane having a very high molecular weight.

A preferred embodiment of the present invention is therefore a method for manufacturing a silylated polyurethane which is wherein in a first step, the polyether block copolymer(s) are reacted with a diisocyanate, with a stoichiometric excess of the polyol compound(s) with respect to the diisocyanate compound, to yield a polyurethane prepolymer that is hydroxyl-terminated and that, in a second step, is reacted with one or more isocyanatosilanes of formula (I)

OCN—R—Si—(R¹)ₘ(—OR²)₃₋ₘ (I)

in which m is 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the polyether compound with the isocyanatosilane.

A further subject of the present invention is a moisture-curing adhesive, sealant, or coating preparation and use thereof, which contains one or more silylated polyurethane(s) of the aforesaid kind. In addition to the silylated polyurethanes according to the present invention, this preparation can also contain plasticizers, fillers, catalysts, and further adjuvants and additives.

The polyether compound required for the reaction according to the present invention with isocyanatosilanes is made up of at least two polyoxyalkylene blocks A and B; preferably, however, this polyether compound possesses a tri-block structure of the A-B-A type. A polyoxyalkylene block copolymer of this kind can be manufactured from an at least difunctional polyether compound B having two terminal hydroxyl groups, onto which, either at one end or preferably at both ends, the polyoxyalkylene block A is polymerized.

Polyethylene oxide (also called polyethylene glycol or “PEG” for short), polytetramethylene glycol (also called “poly-THF”), or polyethers based on dimer diol are particularly suitable as starting compound B. The suitable polyethers based on dimer diol are obtainable under the trade names Sovermol 909 and Sovermol 910 from the Cognis company, and their manufacture is described, for example, in WO 94/26804 A1. Propylene oxide is then polymerized, in a manner known per se, onto this polyoxyalkylene diol or polyalkylene diol B.

In a preferred embodiment of the present invention, the two outer blocks A within a tri-block structure of the A-B-A type are therefore made up of polypropylene oxide. Propylene oxide blocks can be constructed particularly advantageously by DMC catalysis, with the result that polyethers having high molecular weights, concurrently with low polydispersity and low terminal unsaturation, are obtained. This is reflected in relatively low viscosities and therefore good processability for the silylated polyurethanes according to the present invention. The central block B is preferably made up of polyoxytetramethylene (poly-THF), polyoxyethylene (polyethylene oxide), or a polyether based on dimer diol. The blocks are preferably connected to one another by ether bonds.

For the case in which starter block B is not a polyethylene oxide, ethylene oxide can also be used to polymerize on the block or blocks A. The starter polyol B has in this context an average molecular weight from 500 to 10,000; the average molecular weight range of starter block B is preferably between 1000 and 4000 daltons.

Particularly advantageous viscoelastic properties are obtained in the silylated polyurethanes that are to be manufactured if the polyoxyalkylene polymer blocks A polymerized onto the starter polyol B possess a narrow molecular-weight distribution and thus a low polydispersity. This can be achieved, for example, by using a so-called double metal cyanate (DMC) catalyst as the alkoxylation catalyst. Examples of such DMC catalysts are zinc hexacyanocobaltate(II), zinc hexacyanoferrate(III), zinc hexacyanoferrate(II), nickel(II)hexacyanoferrate(II), and cobalt(II)hexacyanocobaltate(III). DMC catalysts of this kind are described, for example, in WO 2006/100219 A1 and the literature cited therein. Very particularly suitable for polymerizing on, according to the present invention, the polyoxyalkylene polymer blocks A are the DMC catalysts known from U.S. Pat. No. 4,477,589 and U.S. Pat. No. 4,472,560, having the general formula

M¹ₐ[M²(CN)_{b}(A)_{c}]_{d}.wM³Dₑ.xH₂O.yL.zHₙEₘ (II)

in which M¹ denotes at least one divalent metal atom selected from Zn(II), Fe(II), Co(II), Ni(II), Mn(II), Cu(II), Sn(II), or Pb(II), and M² is at least one of the di-, tri-, tetra-, or pentavalent metals Fe(II), Fe(III), Co(III), Cr(III), Mn(III), Mn(III), Ir(III), Rh(III), Ru(II), V(IV), or V(V). M³ in this context can be M¹ and/or M², and A, D, and E each denote an anion, which can be the same or different. L is a solvent ligand selected from an alcohol, aldehyde, ketone, ether, ester, amide, nitrile, or sulfide or a mixture thereof; a and d are numbers that correspond to the valence of M¹ and M² in the double metal cyanide portion of general formula (II); b and c denote whole numbers (where b>c) that, together with a and d, yield the electroneutrality of the double metal cyanide portion of general formula (II); e is a whole number that corresponds to the valence of M³, n and m are whole numbers that yield the electroneutrality of HE; w is a number between 0.1 and 4, x is a number up to 20; y is a number between 0.1 and 6, and z is a number between 0.1 and 5.

Also suitable for polymerizing on, according to the present invention, the polyoxyalkylene polymer blocks A are the DMC catalyst complexes known from CN 1459332, made up of a double metal cyanide of the kind recited above, an organic coordination agent, a soluble metal salt, a polyether polyol, and an organic polysiloxane.

In addition to the particularly narrow molecular-weight distribution achievable with these catalysts, the block copolymers manufactured in this fashion are also notable for a high achievable average molecular weight and a very low number of double bonds at the ends of the polymer chains. The polyether blocks A that can be polymerized on in this manner according to the present invention typically have a low polydispersity PD (M_{w}/Mₙ) of at most 2.5, by preference at most 2.0, and particularly preferably between 1.01 and 1.5, for example between approximately 1.08 and 1.14. The products are furthermore notable for their low terminal unsaturation, determinable using ASTM method D4671, which is less than 0.04 meq/g, in particular less than 0.02 meq/g, and preferably 0.01 meq/g.

The block copolymers of the A-B type, or by preference of the A-B-A type, that are to be used according to the present invention have molecular weights between 4000 and 40,000 g/mol (daltons); the preferred range of molecular weights is between 6000 and 20,000 daltons, in particular between 8000 and 19,000 daltons, and very particularly between 10,000 and 18,000 daltons.

The “molecular weight Mₙ” is understood as the number-average molecular weight of the polymer; this, like the weight-average molecular weight M_{w}, can be determined by gel permeation chromatography (GPC, also called SEC). This method is known to one skilled in the art. The polydispersity is derived from the quotient of the average molecular weight M_{w} and Mₙ. It is calculated as PD=M_{w}/Mₙ.

The isocyanatosilanes listed below are suitable for reacting, according to the present invention, the polyether block copolymers of the A-B type or A-B-A type with one or more isocyanatosilanes:

methyldimethoxysilylmethyl isocyanate, ethyldimethoxysilylmethyl isocyanate, methyldiethoxysilylmethyl isocyanate, ethyldiethoxysilylmethyl isocyanate, methyldimethoxysilylethyl isocyanate, ethyldimethoxysilylethyl isocyanate, methyldiethoxysilylethyl isocyanate, ethyldiethoxysilylethyl isocyanate, methyldimethoxysilylpropyl isocyanate, ethyldimethoxysilylpropyl isocyanate, methyldiethoxysilylpropyl isocyanate, ethyldiethoxysilylpropyl isocyanate, methyldimethoxysilylbutyl isocyanate, ethyldimethoxysilylbutyl isocyanate, methyldiethoxysilylbutyl isocyanate, diethylethoxysilylbutyl isocyanate, ethyldiethoxysilylbutyl isocyanate, methyldimethoxysilylpentyl isocyanate, ethyldimethoxysilylpentyl isocyanate, methyldiethoxysilylpentyl isocyanate, ethyldiethoxysilylpentyl isocyanate, methyldimethoxysilylhexyl isocyanate, ethyldimethoxysilyihexyl isocyanate, methyldiethoxysilylhexyl isocyanate, ethyldiethoxysilylhexyl isocyanate, trimethoxysilylmethyl isocyanate, triethoxysilylmethyl isocyanate, trimethoxysilylethyl isocyanate, triethoxysilylethyl isocyanate, trimethoxysilylpropyl isocyanate (e.g. GF 40, Wacker company), triethoxysilylpropyl isocyanate, trimethoxysilylbutyl isocyanate, triethoxysilylbutyl isocyanate, trimethoxysilylpentyl isocyanate, triethoxysilylpentyl isocyanate, trimethoxysilylhexyl isocyanate, triethoxysilylhexyl isocyanate.

Methyldimethoxysilylmethyl isocyanate, methyldiethoxysilylmethyl isocyanate, methyldimethoxysilyipropyl isocyanate, and ethyldimethoxysilylpropyl isocyanate, or trialkoxy analogs thereof, are particularly preferred.

The isocyanatosilane(s) are used in an at least stoichiometric quantity with respect to the hydroxyl groups of the polyol, although a slight stoichiometric excess of the isocyanatosilanes with respect to the hydroxyl groups of the polyol is preferred. This stoichiometric excess is between 0.5 and 10, by preference between 1.2 and 2 equivalents of isocyanate groups referred to the hydroxyl groups.

The following diisocyanates can be used to convert the polyether compound, made up of at least one polyoxyalkylene block A and B, into a hydroxyl-terminated polyurethane prepolymer to be used in alternative fashion:

Ethylene diisocyanate, 1,4-tetramethylene diisocyanate, 1,4-tetramethoxybutane diisocyanate, 1,6-hexamethylene diisocyanate (HDI), cyclobutane 1,3-diisocyanate, cyclohexane 1,3- and 1,4-diisocyanate, bis(2-isocyanatoethyl)fumarate, 1-isocyanato-3,3,5-trimethyl-5-isocyanatomethylcyclohexane(isophorone diisocyanate, IPDI), 2,4- and 2,6-hexahydrotoluylene diisocyanate, hexahydro-1,3- or -1,4-phenylene diisocyanate, benzidine diisocyanate, naphthalene 1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluylene diisocyanate (TDI), 2,4′-diphenylmethane diisocyanate, 2,2′-diphenylmethane diisocyanate, or 4,4′-diphenylmethane diisocyanate (MDI), and isomer mixtures thereof. Also suitable are partly or completely hydrogenated cycloalkyl derivatives of MDI, for example completely hydrogenated MDI (H12-MDI), alkyl-substituted diphenylmethane diisocyanates, for example mono-, di-, tri-, or tetraalkyldiphenylmethane diisocyanate as well as partially or completely hydrogenated cycloalkyl derivatives thereof, 4,4′-diisocyanatophenylperfluorethane, phthalic acid bisisocyanatoethyl ester, 1-chloromethylphenyl-2,4- or -2,6-diisocyanate, 1-bromomethylphenyl-2,4- or -2,6-diisocyanate, 3,3-bischloromethyl ether-4,4′-diphenyldiisocyanate, sulfur-containing diisocyanates such as those obtainable by reacting 2 mol diisocyanate with 1 mol thiodiglycol or dihydroxyhexylsulfide, the diisocyanates of the dimer fatty acids, or mixtures of two or more of the aforesaid diisocyanates.

Monofunctional compounds can also be concurrently used, if applicable, in the manufacture of the hydroxyl-terminated polyurethane prepolymer.

Suitable according to the present invention as monofunctional compounds are those compounds that have groups having a functionality of 1 that are reactive with respect to isocyanates. All monofunctional alcohols, amines, or mercaptans are usable in principle for this; these are, in particular, monofunctional alcohols having up to 36 carbon atoms, monofunctional primary and/or secondary amines having up to 36 carbon atoms, or monofunctional mercaptans having up to 36 carbon atoms. Mixtures of polyalcohols, polyamines, and/or polymercaptans can, however, also be used as monofunctional compounds, provided their average functionality is well below 2.

Particularly preferred, for example, are monoalcohols such as benzyl alcohol, methanol, ethanol, the isomers of propanol, of butanol, and of hexanol, monoethers of ethylene glycol and/or diethylene glycol, and the primary alcohols having 8 to 18 carbon atoms obtainable by reduction of fatty acids, such as octanol, decanol, dodecanol, tetradecanol, hexadecanol, and octadecanol, especially in the form of technical mixtures thereof. Monoalcohols having 4 to 18 carbon atoms are preferred, since the lower alcohols are difficult to manufacture in anhydrous fashion.

Also usable are monoalkylpolyether alcohols of various molecular weights, a number average of the molecular weight of between 1000 and 2000 being preferred. A preferred representative is, for example, monobutylpropylene glycol.

Saturated fatty alcohols having up to 26 carbon atoms can also be used, preferably those having up to 22 carbon atoms that can be synthesized on an industrial scale by reduction (hydrogenation) of fatty acid methyl esters. Examples that may be recited are: hexanol, octanol, pelargonic alcohol, decanol, lauric alcohol, myristic alcohol, cetyl alcohol, stearyl alcohol, gadoleyl alcohol, and behenyl alcohol, or the Guerbet alcohols 2-hexyldecanol, 2-octyldodecanol, 2-decyltetradecanol, 2-dodecylhexadecanol, 2-tetradecyloctadecanol, 2-hexadecyleicosanol, Guerbet alcohol from erucyl alcohol, behenyl alcohol, and ocenols.

If applicable, mixtures resulting from Guerbetization of technical fatty alcohols can be used together with the other aforesaid alcohols.

The proportion of the monofunctional compound(s) is 0 to 40 mol %, based on the polyol mixture; a proportion of monofunctional compound(s) from 15 to 30 mol % is particularly preferred.

The stoichiometric excess of the sum of polyol compounds and monofunctional compound with respect to the diisocyanate compound or mixture of diisocyanates used is equal to 1.1 to 2.0; it is preferably between 1.2 and 1.5 This ensures that a polyurethane prepolymer having terminal hydroxyl groups is formed as a reaction product of step A.

The subsequent reaction of the hydroxyl-terminated polyurethane prepolymer mixture with the isocyanatosilane to yield the silylated polyurethane is accomplished in the same manner as described above for the direct reaction of the polyether compound made up of at least two polyoxyalkylene blocks A and B.

An alternative, urethane-free route to the silylated polymers proceeds from the above-described polyether block copolymers having A-B or A-B-A blocks, and provides for conversion of the OH end groups into terminal allyl groups with the aid of allyl chloride (Williamson ether synthesis). These allyl-terminated polyether block copolymers can then be subjected in known fashion to a hydrosilylation reaction, so that polyether polymers having reactive alkoxysilane groups are produced. The pathway to the aforesaid silylated polyurethane compounds is, however, preferred.

The adhesive and sealant preparations according to the present invention can also contain, in addition to the aforesaid silylated polyurethane compounds, further adjuvants and additives that impart to these preparations improved elastic properties, improved elastic recovery, a sufficiently long processing time, a fast curing time, and low residual tack. Included among these adjuvants and additives are, for example, plasticizers, stabilizers, antioxidants, fillers, reactive diluents, drying agents, adhesion promoters and UV stabilizers, rheological adjuvants, color pigments or color pastes, and/or optionally also, to a small extent, solvents.

Suitable as plasticizers are, for example, adipic acid esters, azelaic acid esters, benzoic acid esters, butyric acid esters, acetic acid esters, esters of higher fatty acids having approximately 8 to approximately 44 carbon atoms, esters of OH-group-carrying or epoxidized fatty acids, fatty acid esters and fats, glycolic acid esters, phosphoric acid esters, phthalic acid esters, linear or branched alcohols containing 1 to 12 carbon atoms, propionic acid esters, sebacic acid esters, sulfonic acid esters (e.g. Mesamoll, alkylsulfonic acid phenyl ester, Bayer company), thiobutyric acid esters, trimellitic acid esters, citric acid esters, and esters based on nitrocellulose and polyvinyl acetate, as well as mixtures of two or more thereof. The asymmetrical esters of adipic acid monooctyl ester with 2-ethylhexanol (Edenol DOA, Cognis Deutschland GmbH, Düsseldorf), or also esters of abietic acid, are particularly suitable.

Suitable among the phthalic acid esters are, for example, dioctyl phthalate (DOP), dibutyl phthalate, diisoundecyl phthalate (DIUP), or butylbenzyl phthalate (BBP) or their derived hydrogenated derivatives, and among the adipates, dioctyl adipate (DOA), diisodecyl adipate, diisodecyl succinate, or dibutyl sebacate or butyl oleate.

Also suitable as plasticizers are the pure or mixed ethers of monofunctional, linear, or branched C₄₋₁₆ alcohols or mixtures of two or more different ethers of such alcohols, for example dioctyl ether (obtainable as Cetiol OE, Cognis Deutschland GmbH, Düsseldorf).

Particularly preferred, however, are end-capped polyethylene glycols such as dialkyl ethers of polyethylene glycol or of polypropylene glycol, in which the alkyl residue is equal to one to four carbon atoms, and in particular the dimethyl and diethyl ethers of diethylene glycol and dipropylene glycol as well as mixtures of two or more thereof. Acceptable curing even under less favorable application conditions (low relative humidity, low temperature) is achieved in particular with dimethyldiethylene glycol. For further details regarding plasticizers, the reader is referred to the relevant chemical engineering literature.

Plasticizers can be additionally used in the preparations at between 0 and 40, by preference between 0 and 20 wt % (based on the entire composition).

“Stabilizers” for purposes of this invention are to be understood as antioxidants, UV stabilizers, or hydrolysis stabilizers. Examples thereof are the commercially usual sterically hindered phenols and/or thioethers and/or substituted benzotriazoles, for example Tinuvin 327 (Ciba Specialty Chemicals), and/or amines of the hindered amine light stabilizer (HALS) type, for example Tinuvin 770 (Ciba Specialty Chemicals). It is preferred in the context of the present invention if a UV stabilizer that carries a silyl group, and that is incorporated into the end product upon crosslinking or curing, is used. The products Lowilite 75, Lowilite 77 (Great Lakes company, USA) are particularly suitable for this purpose. Benzotriazoles, benzophenones, benzoates, cyanoacrylates, acrylates, sterically hindered phenols, phosphorus, and/or sulfur can also be added. The preparation according to the present invention can contain up to approximately 2 wt %, by preference approx. 1 wt % stabilizers. In addition, the preparation according to the present invention can further contain up to approximately 7 wt %, in particular up to approx. 5 wt % antioxidants.

The catalysts that can be used are all known compounds that can catalyze hydrolytic cleavage of the hydrolyzable groups of the silane groupings, as well as subsequent condensation of the Si—OH group to yield siloxane groupings (crosslinking reaction and adhesion promotion function). Examples thereof are titanates such as tetrabutyl titanate and tetrapropyl titanate, tin carboxylates such as dibutyltin dilaulate (DBTL), dibutyltin diacetate, dibutyltin diethylhexanoate, dibutyltin dioctoate, dibutyltin dimethylmaleate, dibutyltin diethylmaleate, dibutyltin dibutylmaleate, dibutyltin diiosooctylmaleate, dibutyltin ditridecylmaleate, dibutyltin dibenzylmaleate, dibutyltin maleate, dibutyltin diacetate, tin octaoate, dioctyltin distearate, dioctyltin dilaulate, dioctyltin diethylmaleate, dioctyltin diisooctylmaleate, dioctyltin diacetate, and tin naphthenoate; tin alkoxides such as dibutyltin dimethoxide, dibutyltin diphenoxide, and dibutyltin diisoproxide; tin oxides such as dibutyltin oxide and dioctyltin oxide; reaction products between dibutyltin oxides and phthalic acid esters, dibutyltin bisacetylacetonate; organoaluminum compounds such as aluminum trisacetylacetonate, aluminum trisethylacetoacetate, and diisopropoxyaluminum ethylacetoacetate; chelate compounds such as zirconium tetraacetylacetonate and titanium tetraacetylacetonate; lead octanoate; amine compounds or salts thereof with carboxylic acids, such as butylamine, octylamine, laurylamine, dibutylamines, monoethanolamines, diethanolamines, triethanolamine, diethylenetriamine, triethylenetetramine, oleylamines, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 2-ethyl-4-methylimidazole, and 1,8-diazabicyclo-(5,4,0)-undecene-7 (DBU), a low-molecular-weight polyamide resin obtained from an excess of a polyamine and a polybasic acid, adducts of a polyamine in excess with an epoxy, silane adhesion promoters having amino groups, such as 3-aminopropyltrimethoxysilane and N-(β-aminoethyl)aminopropylmethyldimethoxysilane. The catalyst, preferably mixtures of several catalysts, are used in a quantity from 0.01 to approximately 5 wt % based on the entire weight of the preparation.

The preparation according to the present invention can additionally contain fillers. Suitable here are, for example, chalk, lime powder, precipitated and/or pyrogenic silicic acid, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

The pyrogenic and/or precipitated silicic acids advantageously have a BET surface area from 10 to 90 m²/g. When they are used, they do not cause any additional increase in the viscosity of the preparation according to the present invention, but do contribute to strengthening the cured preparation.

It is likewise conceivable to use pyrogenic and/or precipitated silicic acids having a higher BET surface area, advantageously 100 to 250 m²/g, in particular 110 to 170 m²/g, as a filler. Because of the greater BET surface area, the same effect, e.g. strengthening the cured preparation, is achieved with a smaller weight proportion of silicic acid. Further substances can thus be used to improve the preparation according to the present invention in terms of different requirements.

Also suitable as fillers are hollow spheres having a mineral shell or a plastic shell. These can be, for example, hollow glass spheres that are obtainable commercially under the trade names Glass Bubbles®. Plastic-based hollow spheres, e.g. Expancel® or Dualite®, are described e.g. in EP 0 520 426 B1. They are made up of inorganic or organic substances and each have a diameter of 1 mm or less, preferably 500 μm or less.

Fillers that impart thixotropy to the preparations are preferred for many applications. Such fillers are also described as rheological adjuvants, e.g. hydrogenated castor oil, fatty acid amides, or swellable plastics such as PVC. In order to be readily squeezable out of a suitable dispensing apparatus (e.g. a tube), such compositions possess a viscosity from 3000 to 150,000, preferably 40,000 to 80,000 mPas, or even 50,000 to 60,000 mPas.

The fillers are used by preference in a quantity from 1 to 80 wt %, by preference from 5 to 60 wt %, based on the total weight of the preparation.

Examples of suitable pigments are titanium dioxide, iron oxides, or carbon black.

In order to enhance shelf life even further, it is often advisable to further stabilize the preparations according to the present invention with respect to moisture penetration using drying agents,. A need occasionally also exists to lower the viscosity of the adhesive or sealant according to the present invention for specific applications, by using a reactive diluent. All compounds that are miscible with the adhesive or sealant with a reduction in viscosity, and that possess at least one group that is reactive with the binder, can be used as reactive diluents.

The following substances can be used, for example, as reactive diluents: polyalkylene glycols reacted with isocyanatosilanes (e.g. Synalox 100-50B, Dow), carbamatopropyltrimethoxysilane, alkyltrimethoxysilane, alkyltriethoxysilane, methyltrimethoxysilane, methyltriethoxysilane, and vinyltrimethoxysilane (Dynasylan VTMO, Evonik or Geniosil XL 10, Wacker), vinyltriethoxysilane, phenyltrimethoxysilane, phenyltriethoxysilane, octyltrimethoxysilane, tetraethoxysilane, vinyldimethoxymethylsilane (XL12, Wacker), vinyltriethoxysilane (GF56, Wacker), vinyltriacetoxysilane (GF62, Wacker), isooctyltrimethoxysilane (IO Trimethoxy), isooctyltriethoxysilane (IO Triethoxy, Wacker), N-trimethoxysilylmethyl-O-methyl carbamate (XL63, Wacker), N-dimethoxy(methyl)silylmethyl-O-methyl carbamate (XL65, Wacker), hexadecyltrimethoxysilane, 3-octanoylthio-1-propyltriethoxysilane, aminosilanes such as 3-aminopropyltrimethoxysilane (Dynasylan AMMO, Evonik or Geniosil GF96, Wacker), and partial hydrolysates of said compounds.

Also usable as reactive diluents are the following polymers of Kaneka Corp.: MS S203H, MS S303H, MS SAT 010, and MS SAX 350.

Silane-modified polymers that are derived, for example, from the reaction of isocyanatosilane with Synalox grades can likewise be used.

In the same fashion, the prepolymers according to the present invention can be used in a mixture with usual polymers or prepolymers known per se, optionally with concurrent use of the aforesaid reactive diluents, fillers, and further adjuvants and additives. “Usual polymers or prepolymers” can be selected in this context from polyesters, polyoxyalkylenes, polyacrylates, polymethacrylates, or mixtures thereof; these can be free of groups reactive with siloxane groups, but optionally can also comprise alkoxysilyl groups or hydroxyl groups.

A plurality of the aforesaid silane-functional reactive diluents have at the same time a drying and/or adhesion-promoting effect in the preparation. These reactive diluents are used in quantities between 0.1 and 15 wt %, by preference between 1 and 5 wt %, based on the entire composition of the preparation.

Also suitable as adhesion promoters, however, are so-called tackifying agents, such as hydrocarbon resins, phenol resins, terpene-phenolic resins, resorcinol resins or derivatives thereof, modified or unmodified resin acids or resin esters (abietic acid derivatives), polyamines, polyaminoamides, anhydrides, and anhydride-containing copolymers. The addition of polyepoxide resins in small quantities can also improve adhesion in many substrates. The solid epoxy resins having a molecular weight of over 700, in finely ground form, are then preferably used for this. If tackifying agents are used as adhesion promoters, their nature and quantity depend on the adhesive/sealant composition and on the substrate onto which it is applied. Typical tackifying resins (tackifiers) such as, for example, terpene-phenolic resins or resin acid derivatives, are used in concentrations between 5 and 20 wt %; typical adhesion promoters such as polyamines, polyaminoamides, or phenolic resins or resorcinol derivatives are used in the range between 0.1 and 10 wt %, based on the entire composition of the preparation.

Manufacture of the preparation according to the present invention occurs in accordance with known methods, by intimate mixing of the constituents in suitable dispersing units, e.g. high-speed mixers, kneaders, planetary mixers, planetary dissolvers, internal mixers, so-called Banbury mixers, double-screw extruders, and similar mixing units known to one skilled in the art.

A preferred embodiment of the preparation according to the present invention can contain:
5 to 50 wt %, preferably 10 to 40 wt %, of one or more compounds of the silylated polyurethanes according to the present invention;
0 to 30 wt %, preferably less than 20 wt %, particularly preferably less than 10 wt % plasticizer;
0 to 80 wt %, preferably 20 to 60 wt %, particularly preferably 30 to 55 wt % fillers.
   The embodiment can also contain further adjuvants.

The totality of all constituents adds up to 100 wt %; the sum of the principal constituents listed above need not alone add up to 100 wt %.

The silylated polyurethane prepolymers according to the present invention cure with ambient atmospheric moisture to yield low-modulus polymers, so that low-modulus, moisture-curing adhesive and sealant preparations can be manufactured from these prepolymers with the aforesaid adjuvants and additives.

The invention will be further explained in the exemplifying embodiments that follow; the selection of examples is not intended to represent any limitation on the scope of the subject matter of the invention.

### EXAMPLES

Catalysts in accordance with the teaching of U.S. Pat. No. 4,477,589 or U.S. Pat. No. 4,472,560 (method A) and in accordance with the teaching of CN 1459332 A (method B) were used in the manufacture of the polyols. After manufacture of the block copolymers of the A-B-A type, 300 ppm BHT was added to them for stabilization.

### Example 1a

### Manufacture of p-THF 1000 PPG 8000 (Method A)

250 g poly-THF (Mₙ 1000) was placed in a 2-liter reactor, and 100 ppm DMC catalyst in accordance with the teaching of U.S. Pat. No. 4,477,589 or U.S. Pat. No. 4,472,560 was added. Subsequently, firstly a vacuum was pulled and then the mixture was acted upon with 1750 g propylene oxide at 110° C., with continued stirring for half an hour after addition.

The product has an OH number of 13.3 and a viscosity of 7500 mPas.

### Example 1b

### Manufacture of p-THF 1000 PPG 8000 (Method B)

The procedure was as described under 1a, but using the DMC catalyst according to the teaching of CN 1459332 A.

The product has an OH number of 13.8 and a viscosity of 5700 mPas.

### Example 2a

### Manufacture of p-THF 1000 PPG 12000 (Method A)

85 g poly-THF (Mₙ 1000) was placed in a 2-liter reactor, and 100 ppm of the DMC catalyst in accordance with the teaching of U.S. Pat. No. 4,477,589 or U.S. Pat. No. 4,472,560 was added. Subsequently, firstly a vacuum was pulled and then the mixture was acted upon with 1915 g propylene oxide at 110° C., with continued stirring for half an hour after addition.

The product has an OH number of 10 and a viscosity of 6000 mPas.

### Example 2b

### Manufacture of p-THF 1000 PPG 12000 (Method B)

The procedure was as described under 2a, but using the DMC catalyst according to the teaching of CN 1459332 A.

The product has an OH number of 10 and a viscosity of 100,000 mPas.

### Example 3

### Manufacture of p-THF 2000 PPG 12000 (Method A)

85 g poly-THF (Mₙ 2000) was placed in a 2-liter reactor, and 200 ppm of the DMC catalyst was added. Subsequently, firstly a vacuum was pulled and then the mixture was acted upon with 1915 g propylene oxide at 110° C., with continued stirring for half an hour after addition.

The product has an OH number of 10 and a viscosity of 9000 mPas.

### Example 4

### Manufacture of PEG 1000 PPG 12000 (Method A)

85 g PEG (Mₙ 1000) was placed in a 2-liter reactor, and 200 ppm of the DMC catalyst was added. Subsequently, firstly a vacuum was pulled and then the mixture was acted upon with 1915 g propylene oxide at 110° C., with continued stirring for half an hour after addition.

The product has an OH number of 14 and a viscosity of 5000 mPas.

Silylation of the polyols manufactured above, using isocyanatosilanes

### Example 5a

300 g (25 mmol) of block copolymer 2a (OH no.=10) was dried under vacuum in a 500 ml three-neck flask at 80° C. 0.07 g dibutyltin laurate was added under a nitrogen atmosphere at 80° C. 12.3 g (60 mmol) 3-isocyanatopropyltrimethoxysilane (Geniosil GF 40) was added to this, and stirred for one hour at 80° C. The resulting prepolymer mixture was cooled, and had 7.0 g Geniosil XL 63 and 5.3 g of a mixture of 70 wt % bis(1,2,2,6,6-pentamethyl-4-piperidyl)sebacate and 30 wt % methyl-1,2,2,6,6-pentamethyl-4-piperidyl sebacate (Tinuvin 765) added to it. The product was stored in moisture-tight fashion under a nitrogen atmosphere in a glass vessel before being further processed into a curable composition in accordance with the general protocol.

### Example 5b

The procedure was the same as described in Example 5a, but the block copolymer from Example 2b was used.

### Example 6

300 g (25 mmol) of the block copolymer (OH no.=10) from Example 2b was dried under vacuum in a 500 ml three-neck flask at 80° C. 0.07 g dibutyltin laurate was added under a nitrogen atmosphere at 80° C. Firstly 4.0 g (25 mmol) 1-isocyanatomethylmethyldimethoxysilane (Geniosil XL 42) was added to this and stirred for 10 minutes, and then 7.1 g 3-isocyanatopropyltrimethoxysilane (Geniosil GF 40) was added and stirred for one hour at 80° C. The resulting prepolymer mixture was cooled, and had 7.0 g Geniosil XL 63 and 5.3 g of a mixture of 70 wt % bis(1,2,2,6,6-pentamethyl-4-piperidyl)sebacate and 30 wt % methyl-1,2,2,6,6-pentamethyl-4-piperidyl sebacate (Tinuvin 765) added to it. The product was stored in moisture-tight fashion under a nitrogen atmosphere in a glass vessel before being further processed into a curable composition in accordance with the general protocol.

### Example 7

The procedure was the same as described in Example 5a, but the block copolymer from Example 3 was used.

### Example 8

The procedure was the same as described in Example 6, but the block copolymer from Example 3 was used.

### Example 9

300 g (38 mmol) of the block copolymer (OH no.=14) from Example 4 was dried under vacuum in a 500 ml three-neck flask at 80° C. 0.07 g dibutyltin laurate was added under a nitrogen atmosphere at 80° C. 18.5 g (90 mmol) 3-isocyanatopropyltrimethoxysilane (Geniosil GF 40) was added to this, and stirred for one hour at 80° C. The resulting prepolymer mixture was cooled, and had 7.0 g Geniosil XL 63 and 5.3 g of a mixture of 70 wt % bis(1,2,2,6,6-pentamethyl-4-piperidyl)sebacate and 30 wt % methyl-1,2,2,6,6-pentamethyl-4-piperidyl sebacate (Tinuvin 765) added to it. The product was stored in moisture-tight fashion under a nitrogen atmosphere in a glass vessel before being further processed into a curable composition in accordance with the general protocol.

General protocol for manufacturing the curable adhesive/sealant preparations according to the present invention:

27.40 parts by weight of the polymer mixture manufactured in Examples 5 to 9 were intimately mixed for 30 s in an agitator vessel, using a SpeedMixer, with 20 parts by weight Mesamoll.

Into the mixture thereby obtained, 45.05 parts by weight calcium carbonate (Omya 302, “ultrafine ground calcium carbonate”), 1.5 parts vinyltrimethoxysilane (“VTMO”, Wacker Geniosil XL10), 1.0 parts by weight 3-aminopropyltrimethoxysilane (“AMMO”, Wacker Geniosil GF96), and 0.05 parts by weight dibutyltin laurate were introduced sequentially, and the resulting mixture was intimately mixed for 30 s in a SpeedMixer.

Test Conditions

Tensile shear strength values on wood/wood, wood/aluminum, and wood/PMMA adhesive bonds were ascertained for these mixtures. Prior to the tensile test, the adhesively bonded test specimens were stored for 7 days in a standard climate (23° C., 50% relative humidity).

The aforementioned mixtures were also applied, at a layer thickness of 2 mm, onto glass plates over which polyether film had been stretched. After 7 days of storage (23° C., 50% relative humidity), test specimens (S2 test specimens) were punched out of these films and mechanical data (modulus of elasticity at 50 and 100% elongation, elongation at fracture, tensile strength, and recovery characteristics) were determined on the basis of DIN EN 27389 and DIN EN 28339.

The results for the curable adhesive/sealant preparations manufactured according to the present invention are compared, in Table 1 below, to those for a curable adhesive/sealant preparation in accordance with the existing art.

As is evident from the strength values, the adhesive/sealant preparations according to the present invention are notable as compared with the comparison example, at comparable values for modulus of elasticity and elongation at fracture, for higher tensile shear strengths, especially when adhesively bonding dissimilar substrates (wood/aluminum or wood/PMMA).

TABLE 1

| Example | 10 | 11 | 12 | 13 | 14 | 15 | 16 |
|---|---|---|---|---|---|---|---|
| Polymer according to existing art ¹⁾ | 27.40 | | | | | | |
| Polymer of Example 5b | | 27.40 | | | | | |
| Polymer of Example 6 | | | 27.40 | | | | |
| Polymer of Example 5a | | | | 27.40 | | | |
| Polymer of Example 7 | | | | | 27.40 | | |
| Polymer of Example 8 | | | | | | 27.40 | |
| Polymer of Example 9 | | | | | | | 27.40 |
| Mesamoll | 15.00 | 15.00 | 15.00 | 15.00 | 15.00 | 15.00 | 15.00 |
| Omyabond 302 | 55.05 | 55.05 | 55.05 | 55.05 | 55.05 | 55.05 | 55.05 |
| VTMO XL 10 | 1.50 | 1.50 | 1.50 | 1.50 | 1.50 | 1.50 | 1.50 |
| AMMO FG 96 | 1.00 | 1.00 | 1.00 | 1.00 | 1.00 | 1.00 | 1.00 |
| Silopren catalyst 162 (DBTL) | 0.05 | 0.05 | 0.05 | 0.05 | 0.05 | 0.05 | 0.05 |
| Results | | | | | | | |
| Fracture (N/mm²) | 2.59 | 2.91 | 2.57 | 2.93 | 3.07 | 2.64 | 2.64 |
| Elongation (%) | 102 | 106 | 113 | 101 | 110 | 136 | 105 |
| E-50 (N/mm²) | 1.77 | 1.70 | 1.51 | 1.64 | 1.71 | 1.22 | 1.62 |
| E-100 (N/mm²) | 2.57 | 2.85 | 2.52 | 2.95 | 2.91 | 2.20 | 2.90 |
| Strength values (N/mm²) | | | | | | | |
| Wood/wood | 4.55 | 5.25 | 4.57 | 4.93 | 4.81 | 4.48 | 4.78 |
| Wood/aluminum | 2.59 | 4.92 | 4.60 | 4.94 | 5.19 | 4.31 | 4.87 |
| Wood/PMMA | 1.80 | 3.59 | 3.72 | 2.35 | 2.74 | 3.20 | 2.80 |

Note
¹⁾ Silylated polyether urethane made of a polypropylene glycol 18000 (diol) and 3-isocyanatopropyltriemethoxysilane.

1. A method for manufacturing a silylated polyurethane, comprising reacting of at least one polyether compound having an OH number per DIN 53783 between 3 and 20 mg KOH/g, made up of at least two polyoxyalkylene blocks A and B, the number of carbon atoms in the alkylene units of blocks A and B differing by at least 1, with one or more isocyanatosilanes of formula (I)
OCN—R—Si—(R¹)ₘ(—OR²)₃₋ₘ (I)
in which m is equal to 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the polyether compound with the isocyanatosilane.

2. The method according to claim 1, wherein the polyether compound has an OH number between 6 and 12 mg KOH/g.

3. The method according to claim 1, wherein polyoxyalkylene block A comprises alkylene units having an even number of carbon atoms, and polyoxyalkylene block B comprises alkylene units having an odd number of carbon atoms.

4. The method according to claim 1, wherein the first polyether block A contains polyoxytetramethylene units, and the second block B contains polyoxypropylene units.

5. The method according to claim 1, wherein the first polyether block A contains polyoxyethylene units, and the second block B contains polyoxypropylene units.

6. The method according to claim 1, wherein the first polyether block A is made up of dimer diol ether units, and the second block B contains polyoxypropylene units.

7. The method according to claim 1, wherein the polyether compound has a tri-block structure of the A-B-A type.

8. The method according to claim 1, wherein in a first step, the polyether block copolymer(s) are reacted with a diisocyanate, with a stoichiometric excess of the polyol compound(s) with respect to the diisocyanate compound, to yield a polyurethane prepolymer that is hydroxyl-terminated and that, in a second step, is reacted with one or more isocyanatosilanes of formula (I)
OCN—R—Si—(R¹)ₘ(—OR²)₃₋ₘ (I)
in which m is equal to 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the polyether compound with the isocyanatosilane.

9. The method according to claim 1, wherein R is a difunctional straight or branched alkyl residue having 2 to 6 carbon atoms.

10. The method according to claim 1, wherein m is zero.

11. The method according to claim 1, wherein m is one.

12. The method according to claim 8, wherein the polyol mixture additionally contains at least one compound that is monofunctional with respect to isocyanates, selected from monoalcohols, monomercaptans, monoamines, or mixtures thereof, and the proportion of monofunctional compound is equal to 1 to 40 mol % of the mixture of polyol and the monofunctional compound.

13. The method according to claim 1, wherein the isocyanatosilane of formula (I) is 3-isocyanatopropyltrimethoxysilane or 3-isocyanatopropyltriethoxysilane.

14. A silylated polyurethane manufactured using a method encompassing reaction of at least one polyether compound having an OH number per DIN 53783 between 3 and 20 mg KOH/g, made up of at least two polyoxyalkylene blocks A and B, the number of carbon atoms in the alkylene units of blocks A and B differing by at least 1, with one or more isocyanatosilanes of formula (I)
OCN—R—Si—(R¹)ₘ(—OR²)₃₋ₘ (I)
in which m is equal to 0, 1, or 2, each R² is an alkyl residue having 1 to 4 carbon atoms, each R¹ is an alkyl residue having 1 to 4 carbon atoms, and R is a difunctional organic group, in order to cap the hydroxyl groups of the prepolymer with the isocyanatosilane.

15. The silylated polyurethane according to claim 14, wherein the polyether compound has an OH number between 6 and 12 mg KOH/g.

16. The silylated polyurethane according to claim 14, wherein m is zero.

17. The silylated polyurethane according to claim 14, wherein m is one.

18. The silylated polyurethane according to claim 14, wherein the isocyanatosilane of formula (I) is 3-isocyanatopropyltrimethoxysilane or 3-isocyanatopropyltriethoxysilane.

19. A polyol compound having polytetramethylene oxide blocks and polypropylene oxide and/or polyethylene oxide blocks, having an OH number per DIN 53783 between 3 and 20, preferably between 5 and 10 mg KOH/g.

20. A silylated polyurethane manufactured in accordance with a method according to claim 8, wherein the diisocyanate compound is selected from the group made up of 2,4-toluene diisocyanate, 2,6-toluene diisocyanate, 4,4′-diphenylmethane diisocyanate, 2,4′-diphenylmethane diisocyanate, 1-isocyanato-3,3,5-trimethyl-5-isocyanatomethylcyclohexane (isophorone diisocyanate, IPDI), 4,4′-dicyclohexylmethane diisocyanate isomers, tetramethylxylylene diisocyanate (TMXDI), and mixtures thereof.

21. The silylated polyurethane according to claim 20, wherein the polyol mixture additionally contains at least one compound that is monofunctional with respect to isocyanates, selected from monoalcohols, monomercaptans, monoamines, or mixtures thereof, and the proportion of monofunctional compound is equal to 1 to 40 mol % of the mixture of polyol and the monofunctional compound.

22. An adhesive, sealant or coating containing one or more silylated polyurethane(s) according to claim 14.
